(19) United States
(12) Patent Application Publication
(10) Pub. No.: US 2014/0217336 A1
(43) Pub. Date: Aug. 7, 2014

(54) SOLAR-PUMPED LASER DEVICE, SOLAR-PUMPED AMPLIFIER AND LIGHT-AMPLIFYING GLASS

(71) Applicant: ASAHI GLASS COMPANY, LIMITED, Chiyoda-ku (JP)

(72) Inventors: Seiki OHARA, Tokyo (JP); Yuya Shimada, Tokyo (JP)

(73) Assignee: ASAHI GLASS COMPANY, LIMITED, Chiyoda-ku (JP)

(21) Appl. No.: 14/246,613

(22) Filed: Apr. 7, 2014

Related U.S. Application Data
(63) Continuation of application No. PCT/JP2012/071882, filed on Aug. 29, 2012.

(30) Foreign Application Priority Data
Oct. 7, 2011 (JP) 2011-223073

(51) Int. Cl. C03C 3/15

(52) U.S. Cl. CPC C03C 3/15
USPC 252/582

(57) ABSTRACT

To provide a laser oscillation device capable of generating laser oscillation by efficiently absorbing sunlight. A solar-pumped laser oscillation device wherein the gain medium is Nd-containing B₂O₃—Bi₂O₃ glass. The solar-pumped laser oscillation device wherein the gain medium contains Yb. The solar-pumped laser oscillation device wherein the matrix glass of the Nd-containing B₂O₃—Bi₂O₃ glass comprises from 20 to 65 mol % of B₂O₃ and from 10 to 48 mol % of Bi₂O₃.

This application is a continuation of PCT Application No. PCT/JP2012/071882, filed on Aug. 29, 2012, which is based upon and claims the benefit of priority from Japanese Patent Application No. 2011-223073 filed on Oct. 7, 2011. The contents of those applications are incorporated herein by reference in its entirety.

### TECHNICAL FIELD

The present invention relates to a laser oscillation device having a gain medium to be excited typically by sunlight and a solar-pumped amplifier as well as light-amplifying glass.

### BACKGROUND ART

In recent years, there have been research and development activities for effective use of natural energy in order to solve energy problems. Particularly, solar photovoltaic power generation or solar thermal power generation utilizing solar energy has reached a level of practical use. On the other hand, as a new method of use of solar energy, it has been proposed to convert the energy of sunlight to laser light and to refine a metal by means of such laser light (Patent Documents 1 and 2). As a laser medium, crystals or ceramics of e.g. Nd-doped YAG have been used.

Further, Nd-doped YAG crystals or YAG ceramics show highly efficient light-amplifying characteristics when they are excited by a laser diode with an excitation wavelength of 808 nm (Non-patent Document 1).

### PRIOR ART DOCUMENTS

### Patent Documents

Patent Document 1: WO 2009/128510
Patent Document 2: WO 2010/050450

### Non-Patent Document

Non-patent Document 1: J. Lu, et al, “Optical properties and highly efficient laser oscillation of Nd:YAG ceramics”, Applied Physics B, Vol 71, 2000, p. 469-473

### DISCLOSURE OF INVENTION

### Technical Problems

With e.g. a laser diode, highly efficient amplifying characteristics are obtainable by excitation with a specific wavelength having a large absorption coefficient.

However, in a case where light having a wide wavelength range such as sunlight was used as excitation light, there was a problem that light with a continuous wavelength could not be efficiently absorbed by e.g. YAG crystals or YAG ceramics having fine structures for absorption as shown in Non-patent Document 1.

Further, in order to increase the gain, it is necessary to increase a size, and for this purpose, it was necessary to take a measure to prevent thermal cracking of YAG crystals or YAG ceramics.

Further, YAG crystals had a problem that it took a long time for their preparation, and their mass production was impossible.

It is an object of the present invention to provide a solar-pumped laser oscillation device, a solar-pumped amplifier and light-amplifying glass which are capable of solving such problems.

### Solution to Problems

The present invention provides a solar-pumped laser oscillation device (hereinafter sometimes referred to as the laser oscillation device of the present invention) wherein the gain medium is Nd-containing B₂O₃—Bi₂O₃ glass.

Further, it provides the above solar-pumped laser oscillation device, wherein the Nd-containing B₂O₃—Bi₂O₃ glass is glass having Nd₂O₃ added to a matrix glass comprising from 20 to 65 mol % of B₂O₃ and from 10 to 48 mol % of Bi₂O₃.

Further, it provides the above solar-pumped laser oscillation device, wherein the matrix glass contains at most 60 mol % of TeO₂.

Further, it provides the above solar-pumped laser oscillation device, wherein the matrix glass contains no SiO₂.

Further, it provides the above solar-pumped laser oscillation device, wherein the proportion of Nd₂O₃ added, is from 0.003 to 0.025 by molar ratio to the matrix glass.

Further, it provides the above solar-pumped laser oscillation device, wherein the Nd-containing B₂O₃—Bi₂O₃ glass contains Yb.

Further, it provides the above solar-pumped laser oscillation device, wherein the proportion of Yb₂O₃ added, is from 0.001 to 0.025 by molar ratio to the glass matrix.

Further, it provides a solar-pumped amplifier (hereinafter sometimes referred to as the amplifier of the present invention) wherein a gain medium made of Nd-containing B₂O₃—Bi₂O₃ glass is excited by sunlight to conduct amplification of light entered the gain medium.

Further, it provides the above solar-pumped amplifier, wherein the Nd-containing B₂O₃—Bi₂O₃ glass is glass having Nd₂O₃ added to a matrix glass comprising from 20 to 65 mol % of B₂O₃ and from 10 to 48 mol % of Bi₂O₃.

Further, it provides the above solar-pumped amplifier, wherein the matrix glass contains at most 60 mol % of TeO₂.

Further, it provides the above solar-pumped amplifier, wherein the matrix glass contains no SiO₂.

Further, it provides the above solar-pumped amplifier, wherein the proportion of Nd₂O₃ added, is from 0.003 to 0.025 by molar ratio to the matrix glass.

Further, it provides the above solar-pumped amplifier, wherein the Nd-containing B₂O₃—Bi₂O₃ glass contains Yb.

Further, it provides the above solar-pumped amplifier, wherein the proportion of Yb₂O₃ added, is from 0.001 to 0.025 by molar ratio to the glass matrix.

Further, it provides light-amplifying glass (hereinafter sometimes referred to as the glass of the present invention) having Nd₂O₃ added to a matrix glass comprising from 20 to 65 mol % of B₂O₃ and from 10 to 48 mol % of Bi₂O₃, wherein the proportion of Nd₂O₃ added, is from 0.003 to 0.025 by molar ratio to the matrix glass.

Further, it provides the above light-amplifying glass, wherein the matrix glass contains at most 60 mol % of TeO₂.

Further, it provides the above light-amplifying glass, wherein the matrix glass contains no SiO₂.

Further, it provides the above light-amplifying glass, which contains Yb.

Further, it provides the above light-amplifying glass, wherein the proportion of Yb₂O₃ added, is from 0.001 to 0.025 by molar ratio to the glass matrix.

### Advantageous Effects of Invention

According to the present invention, it becomes possible to efficiently absorb light even if the gain medium or light-amplifying glass is excited by continuous light. As a result, a large gain is obtainable, and laser light is obtainable with high efficiency.

Further, it becomes possible to reduce the size of the gain medium or light-amplifying glass, and the proportion of the surface area to the volume increases to facilitate heat dissipation.

Further, the glass can be formed by melting a raw material by heating, followed by casting the molten glass, and therefore, the gain medium or light-amplifying glass can easily be prepared, and its mass production is possible.

### BRIEF DESCRIPTION OF DRAWINGS

FIG. 1 is a schematic view of the solar-pumped laser oscillation device of the present invention.

FIG. 2 is another schematic view of the solar-pumped laser oscillation device of the present invention.

FIG. 3 is a schematic view of the solar-pumped amplifier of the present invention.

FIG. 4 is another schematic view of the solar-pumped amplifier of the present invention.

FIG. 5 is a graph showing the absorption spectrum of the light-amplifying glass of the present invention.

FIG. 6 is a graph showing the absorption spectrum of the Nd-added YAG ceramics.

FIG. 7 is a graph showing the emission intensity spectra of the light-amplifying glass of the present invention wherein Nd is added (Example 2) and the light-amplifying glass of the present invention wherein, in addition to Nd, Yb is added (Example 17).

### DESCRIPTION OF EMBODIMENTS

In the laser oscillation device of the present invention, typically Nd-containing B₂O₃—Bi₂O₃ glass as a gain medium is disposed between a mirror (reflection mirror) with a reflectance of at least 90% and a mirror (output mirror) with a reflectance of at most 50%, which constitute a resonator, and introduction of light such as sunlight into the gain medium is conducted by e.g. a lens or mirror. The introduction of sunlight into the gain medium may be conducted by collection of light in two stages, as the case requires. Further, the excitation light is typically continuous light such as sunlight and is usually applied to the gain medium from its side surface by means of a lens, but may not be so limited. As the lens in such a case, a Fresnel lens may, for example, be used. Further, in this specification, for example “excited by sunlight” includes a case where excited by e.g. continuous light without being limited to sunlight.

In the amplifier of the present invention, typically, continuous light such as sunlight as the excitation light is introduced to the gain medium by means of e.g. a lens or mirror, and at that time, collection of light may be conducted in two stages as the case requires. Further, usually at the same time as introduction of the excitation light, light (signal light) with a wavelength to be amplified, is introduced to the gain medium, but the manner of introduction of light may not be so limited.

The shape of the gain medium is not particularly limited, and it may, for example, be a rod-form or a plate-form. A rod-form gain medium may, for example, have a size of e.g. 3 mm in diameter and 80 mm in length, and a plate-form gain medium may, for example, have a size of e.g. 30 mm square and 3 mm in thickness. Further, the gain medium may have a structure such that the glass of the present invention constitutes a core, and the core is covered with a clad material having a refractive index lower than the core.

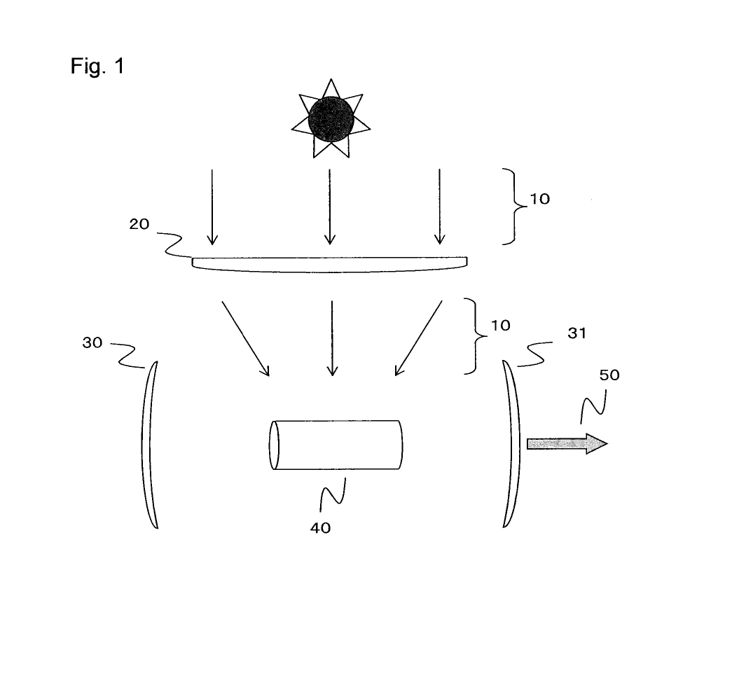

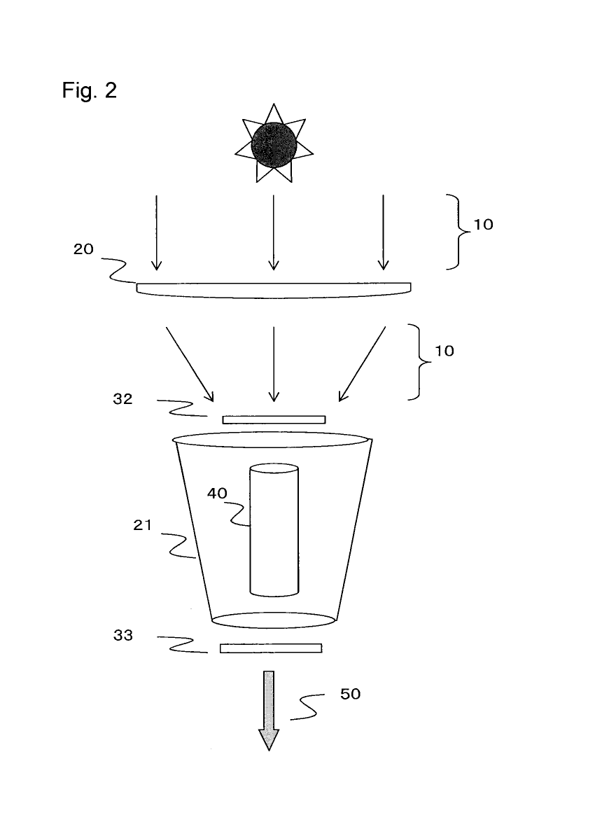

FIGS. 1 and 2 show schematic constructions of the laser oscillation device of the present invention.

FIG. 1 is a schematic view illustrating a schematic construction of one embodiment of the laser oscillation device of the present invention. Sunlight 10 excites a gain medium 40 by a condensing lens 20. By a resonator constituted by a reflection mirror 30 and an output mirror 31, laser light 50 is obtainable.

FIG. 2 is a schematic view illustrating a schematic construction of another embodiment of the laser oscillation device of the present invention. Sunlight collected by a condensing lens 20 is introduced directly to a gain medium 40 and also reflected by a reflecting surface 21 and then introduced to the gain medium 40. As the reflecting surface 21, a shape having a part of a circular cone or multi-sided pyramid cut off may be employed. By a resonator constituted by a reflection mirror 32 and an output mirror 33, laser light 50 is obtainable.

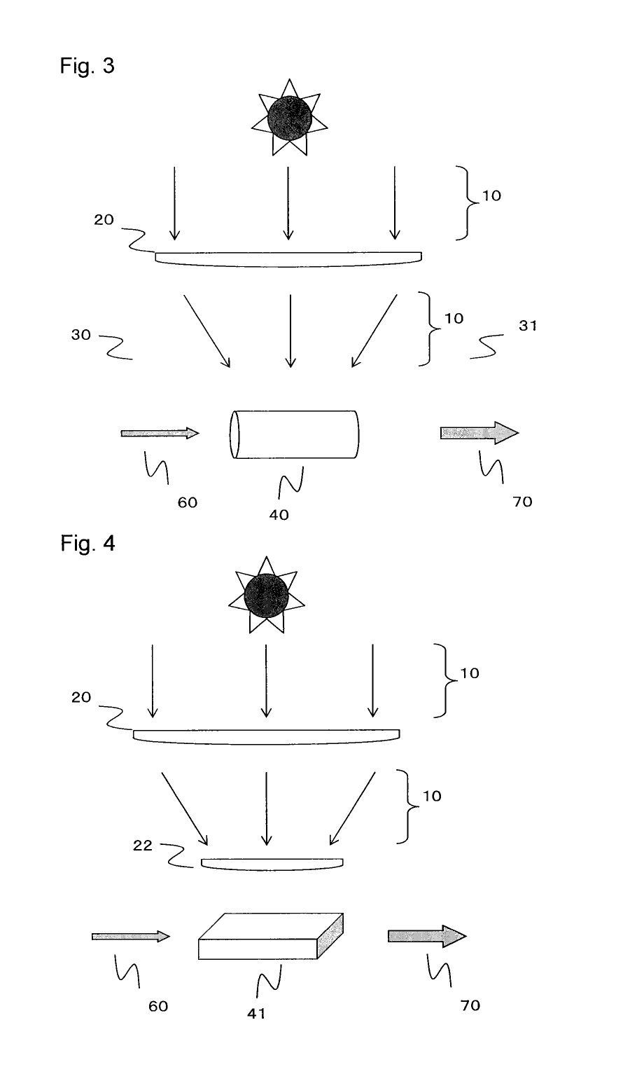

FIGS. 3 and 4 show schematic constructions of the amplifier of the present invention.

FIG. 3 is a schematic view illustrating a schematic construction of one embodiment of the amplifier of the present invention. Signal light 60 is amplified by a gain medium 40 excited by sunlight 10 collected by a condensing lens 20, whereby amplified light 70 is obtainable.

FIG. 4 is a schematic view illustrating a schematic construction of another embodiment of the amplifier of the present invention. Signal light 60 is amplified by a gain medium 41 excited by sunlight 10 collected by a secondary condensing lens 22, whereby amplified light 70 is obtainable.

In the gain medium of the laser oscillation device and the amplifier of the present invention (hereinafter sometimes referred to as the gain medium of the present invention) as well as in the glass of the present invention, light amplification is carried out by utilizing stimulated emission from ⁴F_{3/2} level to ⁴I_{11/2} level of Nd³⁺.

Such light amplification is suitable for amplification of light with a wavelength of from 1.0 to 1.2 μm.

Further, by adding Yb₂O₃ together with Nd₂O₃, an energy shift from ⁴F_{3/2} level of Nd³⁺ to ²F_{5/2} of Yb³⁺ takes place, whereby larger light amplification is carried out.

Such light amplification is suitable for amplification of light with a wavelength of from 0.9 to 1.2 μm. Further, by permitting laser light and continuous light such as sunlight to enter the laser oscillation device or the amplifier of the present invention, or the glass of the present invention, it is possible to amplify the intensity of the laser light. The gain medium and the glass of the present invention (hereinafter sometimes referred to as the gain medium, etc. of the present invention) are preferably capable of absorbing light of from 1.2 eV (wavelength: 1033 nm) to 3 eV (wavelength: 413 nm) with good efficiency. Such ones are capable of efficiently exciting even continuous light such as sunlight.

From such a viewpoint, it is preferred that in the gain medium, etc. of the present invention, when excited with light of 2.33 eV (wavelength: 532 nm), the product of the emission lifetime and the emission intensity at a wavelength of 1064 nm (photon energy=1.165 eV) is large. Specifically, the after-described index Y for quasi-emission-efficiency is preferably at least 140 eV·ms, more preferably at least 180 eV·ms.

Further, it is preferred that in the gain medium, etc. of the present invention, when excited with light of 2.33 eV, the sum of the product of the emission lifetime and the emission intensity at a wavelength of 977 nm (photon energy=1.269 eV) and the product of the emission lifetime and the emission intensity at a wavelength of 1064 nm (photon energy=1.165 eV) is large. Specifically, the after-described index Y′ for quasi-emission-efficiency is preferably at least 380 eV·ms, more preferably at least 770 eV·ms, further preferably at least 1,100 eV·ms.

Y and Y′ are indices for quasi-emission-efficiency. Y is an index for quasi-emission-efficiency by Nd and is preferably at least 140 eV·ms, and Y′ is an index for quasi-emission-efficiency by Nd and Yb and is preferably at least 770 eV·ms.

The gain medium, etc. of the present invention are glass containing, as the main component, B₂O₃ as a glass network former, whereby they are stable as glass, and they contain Bi₂O₃ as another main component, whereby the after-described concentration quenching is less likely to occur. Further, as they contain both B₂O₃ and Bi₂O₃, they are thermally stable.

Further, as compared with a case where the gain medium or glass constituting the gain medium is a SiO₂ type glass, they are excellent in the melting properties at a high temperature at the time of preparing glass.

In this specification, the content of each component in glass is represented by mol percentage as a rule, and in the following, “mol %” is referred to simply as “%”.

The gain medium, etc. of the present invention are glass having Nd added to a matrix glass comprising B₂O₃—Bi₂O₃. The matrix glass is preferably one which may be easily vitrified, and typically comprises from 20 to 65% of B₂O₃ and from 10 to 48% of Bi₂O₃. Further, in a case where the gain medium, etc. of the present invention contain Yb, the gain medium, etc. of the present invention are glass having Nd and Yb added to a matrix glass comprising B₂O₃—Bi₂O₃. Here, the proportions of Nd and Yb added are, as added as Nd₂O₃ and Yb₂O₃, respectively, represented by molar ratios to the matrix glass, of a value calculated as Nd₂O₃ and a value calculated as Yb₂O₃.

Now, the compositions of this typical matrix glass and the glass of the present invention will be described.

B₂O₃ is a network former and a component to facilitate glass formation by preventing crystallization during the preparation of glass and is essential. If it is less than 20%, vitrification tends to be difficult. It is preferably at least 25%, more preferably at least 30%, particularly preferably at least 33%. If it exceeds 65%, the emission intensity tends to be low. It is preferably at most 60%, more preferably at most 50%, particularly preferably at most 45%.

Bi₂O₃ is an essential component. If its content is less than 10%, vitrification tends to be difficult, or, if the amount of Nd added is increased, the emission intensity tends to be low due to non-radiative relaxation, i.e. concentration quenching is likely to occur. It is preferably at least 15%, more preferably at least 20%, particularly preferably at least 25%, most preferably at least 30%. If it exceeds 48%, vitrification tends to be difficult. It is preferably at most 45%, more preferably at most 42%, particularly preferably at most 40%.

In a case where it is desired to prevent the concentration quenching from occurring or to further increase the emission intensity, TeO₂ may be contained, although it is not essential to contain it. The content of TeO₂ in such a case is preferably from 5 to 60 mol %. If it is less than 5%, the above-mentioned object tends to be hardly accomplished, and it is more preferably at least 10%, typically at least 15%. If it exceeds 60%, glass is likely to be devitrified, and it is more preferably at most 50%, typically at most 35%.

The above-mentioned typical matrix glass of the gain medium of the present invention or the matrix glass of the glass of the present invention is composed essentially of such three components. However, other components may be contained within a range not to impair the object of the present invention. Even in such a case, the total content of the above three components is preferably at least 70%, more preferably at least 80%, particularly preferably at least 85%, typically at least 90%.

Now, such other components will be exemplified.

SiO₂ may be contained as a network former in order to stabilize glass. In a case where SiO₂ is contained, if it is less than 1%, its effect is small. It is preferably at least 2%, more preferably at least 5%. If it exceeds 15%, the melting temperature tends to increase. It is preferably at most 10%, more preferably at most 8%. No SiO₂ should better be contained e.g. in a case where it is desired to improve the melting properties.

La₂O₃ has an effect to prevent concentration quenching from occurring or an effect to increase the emission intensity and may be contained in an amount of up to 4%. If it exceeds 4%, devitrification is likely to occur. It is more preferably at most 3%. In a case where La₂O₃ is contained, its content is preferably at least 0.5%, more preferably at least 1%, particularly preferably at least 2%.

In a case where it is desired to let the energy of excitation light be absorbed and to let energy transfer to Nd occur, Er₂O₃, Tm₂O₃, Yb₂O₃, Sm₂O₃, Ho₂O₃, CrO, etc. may be added. Especially when Yb₂O₃ is added together with Nd₂O₃, energy transfer from excited Nd to Yb takes place, whereby an intensive emission of Yb is obtainable.

Further, in order to facilitate vitrification, Li₂O, Na₂O, K₂O, MgO, CaO, SrO, BaO, ZrO₂, ZnO, GeO₂, TiO₂, In₂O₃, P₂O₅, Nb₂O₅, Ta₂O₅, etc. may be contained.

Now, the content of Nd will be described. Here, the content of Nd is, as Nd is added as Nd₂O₃ to the matrix glass, represented by molar ratio calculated as Nd₂O₃ to the matrix glass.

If Nd₂O₃ is less than 0.003, no adequate amplification is obtainable or is likely to be obtainable. It is preferably at least 0.005, more preferably at least 0.01. In a case where a small one is used as the gain medium or the glass of the present invention, the proportion of Nd₂O₃ added is preferably at least 0.005, more preferably at least 0.01. Further, if it exceeds 0.025, vitrification becomes difficult or is likely to become difficult. It is preferably at most 0.02. In a case where it is desired to prevent an influence of concentration quenching, the proportion of Nd₂O₃ added is preferably at most 0.02, more preferably at most 0.01.

Now, in a case where Yb is added, the content of Yb will be described. Here, the content of Yb is, as Yb is added as Yb₂O₃ to the matrix glass, represented by molar ratio calculated as Yb₂O₃ to the matrix glass.

In a case where Yb₂O₃ is added, its proportion is preferably from 0.001 to 0.025. If it is less than 0.001, no adequate amplification is obtainable or is likely to be obtainable. It is preferably at least 0.005, more preferably at least 0.008. In a case where a small one is used as the gain medium, etc. of the present invention, the proportion of Yb₂O₃ added is preferably at least 0.005, more preferably at least 0.008. Further, if it exceeds 0.025, vitrification becomes difficult or is likely to become difficult. It is preferably at most 0.02. In a case where it is desired to prevent an influence of concentration quenching, the proportion of Yb₂O₃ added is preferably at most 0.02, more preferably at most 0.01.

The method for preparing the glass of the present invention or the glass for the gain medium of the present invention is not particularly limited, and it may be prepared, for example, by a melting method wherein raw material is compounded, mixed and put in a gold crucible, an alumina crucible, a quartz crucible or a iridium crucible, and melted in air at from 800 to 1,300° C., and the obtained melt is cast in a prescribed mold. Otherwise, it may be prepared by a method other than the melting method, such as a sol-gel method or a vapor deposition method.

### Examples

Glass in each of Examples 1 to 13 and Examples 15 to 22 was prepared by a melting method to have a composition shown in columns for from B₂O₃ to Nd₂O₃ or Yb₂O₃ in Tables 1 to 3, wherein the proportions of Nd₂O₃ and Yb₂O₃ added are ones having their molar ratios to the matrix glass multiplied by 100, and the contents of other components are represented by mol %. Examples 1 to 10 and 15 to 21 are working examples of the present invention, Examples 11 and 12 are comparative examples wherein glass was not obtained due to devitrification, and Examples 13 and 22 are also comparative examples.

Further, at the time of excitation with light having a wavelength of 532 nm (photon energy: 2.33 eV, the same applies hereinafter), area E of emission intensity within a range of from a wavelength of 990 nm (1.25 eV) to a wavelength of 1180 nm (1.05 eV), emission intensity E (977) at a wavelength of 977 nm (1.269 eV), emission intensity E (1064) at a wavelength of 1064 nm (1.165 eV), emission lifetime τ(977) at a wavelength of 977 nm, and emission lifetime τ(1064) (unit: ms) at a wavelength of 1064 nm, are shown in Tables 1 to 3.

Here, area E of emission intensity is represented by a relative value when E of Nd-containing YAG ceramics (tradename: transparent YAG ceramics) manufactured by Konoshima Chemical Co., Ltd. in Example 14 is regarded to be 1, and E (977) and E (1064) are represented by relative values when E (1064) in Example 2 is regarded to be 1.

Further, absorbance A (532) (unit: /cm) at a peak of a wavelength of 532 (2.33 eV), peak value A (unit: /cm) of absorbance in a range of from 1.2 eV (wavelength: 1033 nm) to 3 eV (wavelength: 411 nm), and absorbance area A′ (unit: eV/cm) in a range of from 1.2 eV to 3 eV, as well as Y=E×τ(1064)×A′/A(532) and Y′={E(1064)×τ(1064)+E (977)×τ(977)}×A′/A (532) as indices for a product of the emission intensity and the emission lifetime, are shown in Tables 1 to 3.

In Examples 1 to 4, the matrix glass is the same, but the proportion of Nd₂O₃ added is different. It is evident that the absorption of light increases as the proportion of Nd₂O₃ added increases.

Further, it is evident that in Examples 1 to 10 as working examples of the present invention, Y as an index for quasi-emission-efficiency is at least 140 eV·ms, while in Example 13 as a comparative example, Y is a value as small as 15 eV·ms.

Further, when Examples 1, 2, 15 and 3 wherein Yb₂O₃ is not contained, are compared with Examples 19, 16 to 18, 20 and 21 wherein Yb₂O₃ is added, it is evident that by the addition of Yb₂O₃, Y′ as an index for quasi-emission-efficiency is increased to at least 778 eV·ms.

Further, with respect to glass in Example 22 wherein Yb₂O₃ is contained, but Nd₂O₃ is not contained, the emission intensity was measured, whereby no emission was observed. This indicates that the cause for the increase of Y′ in Examples 16 to 21 is attributable to an energy shift from ⁴F_{3/2} level of Nd³⁺ to ²F_{5/2} level of Yb³⁺ by the addition of Yb₂O₃ together with Nd₂O₃.

TABLE 1

| | Ex. 1 | Ex. 2 | Ex. 3 | Ex. 4 | Ex. 5 | Ex. 6 | Ex. 7 |
|---|---|---|---|---|---|---|---|
| B₂O₃ | 40 | 40 | 40 | 40 | 34 | 50 | 30 |
| Bi₂O₃ | 40 | 40 | 40 | 40 | 33 | 40 | 15 |
| TeO₂ | 20 | 20 | 20 | 20 | 33 | 10 | 55 |
| Nd₂O₃ | 0.5 | 1.0 | 2.0 | 3.0 | 1.5 | 1.5 | 1.5 |
| E | 0.32 | 0.47 | 0.44 | 0.31 | 0.60 | 0.43 | 0.60 |
| E (977) | 0 | 0 | 0 | 0 | 0 | 0 | 0 |
| E (1064) | 0.67 | 1.00 | 0.92 | 0.66 | 1.24 | 0.87 | 0.27 |
| τ (977) | — | — | — | — | — | — | — |
| τ (1064) | 380 | 329 | 331 | 320 | 358 | 318 | 392 |
| A (532) | 0.8 | 1.5 | 3.0 | 4.5 | 2.5 | 2.2 | 2.5 |
| A | 6.8 | 13.5 | 27.8 | 40.8 | 21.1 | 19.4 | 25.2 |
| A′ | 1.2 | 2.3 | 4.3 | 6.3 | 3.4 | 3.2 | 3.6 |
| Y | 187 | 232 | 207 | 140 | 288 | 199 | 334 |
| Y′ | 383 | 504 | 438 | 296 | 605 | 401 | 154 |

TABLE 2

| | Ex. 8 | Ex. 9 | Ex. 10 | Ex. 11 | Ex. 12 | Ex. 13 | Ex. 14 |
|---|---|---|---|---|---|---|---|
| B₂O₃ | 40 | 55 | 63.2 | 50 | 32 | 0 | — |
| Bi₂O₃ | 20 | 45 | 31.6 | 50 | 8 | 0 | — |
| TeO₂ | 40 | 0 | 5.3 | 0 | 60 | 0 | — |
| SiO₂ | 0 | 0 | 0 | 0 | 0 | 70.2 | — |
| Al₂O₃ | 0 | 0 | 0 | 0 | 0 | 0.9 | — |
| MgO | 0 | 0 | 0 | 0 | 0 | 6.3 | — |
| CaO | 0 | 0 | 0 | 0 | 0 | 8.7 | — |
| Na₂O | 0 | 0 | 0 | 0 | 0 | 13.5 | — |
| K₂O | 0 | 0 | 0 | 0 | 0 | 0.3 | — |
| Nd₂O₃ | 1.5 | 1.5 | 1.5 | 0 | 0 | 2.0 | 1.0 |
| E | 0.52 | 0.39 | 0.29 | — | — | 0.32 | 1 |
| E (977) | 0 | 0 | 0 | — | — | 0 | 0 |
| E (1064) | 0.27 | 0.77 | 0.56 | — | — | 0.46 | 2.62 |
| τ (977) | — | — | — | — | — | — | — |
| τ (1064) | 366 | 413 | 355 | — | — | 55 | 220 |
| A (532) | 2.2 | 2.2 | 1.6 | — | — | 5.1 | 1.0 |
| A | 23.1 | 18.8 | 18.1 | — | — | 25.5 | 5.6 |
| A′ | 3.5 | 3.1 | 3.0 | — | — | 4.4 | 0.6 |
| Y | 296 | 227 | 188 | — | — | 15 | 134 |
| Y′ | 159 | 451 | 370 | — | — | 22 | 346 |

TABLE 3

| | Ex. 15 | Ex. 16 | Ex. 17 | Ex. 18 | Ex. 19 | Ex. 20 | Ex. 21 | Ex. 22 |
|---|---|---|---|---|---|---|---|---|
| B₂O₃ | 40 | 40 | 40 | 40 | 40 | 40 | 40 | 40 |
| Bi₂O₃ | 40 | 40 | 40 | 40 | 40 | 40 | 40 | 40 |
| TeO₂ | 20 | 20 | 20 | 20 | 20 | 20 | 20 | 20 |
| Nd₂O₃ | 1.5 | 1 | 1 | 1 | 0.5 | 1.5 | 2 | 0 |
| Yb₂O₃ | 0 | 0.5 | 1 | 2 | 1 | 1 | 1 | 0.5 |
| E | 0.63 | 0.75 | 1.12 | 0.99 | 0.91 | 1.87 | 0.75 | 0 |
| E (977) | 0 | 0.94 | 1.42 | 1.11 | 0.79 | 2.00 | 2.27 | 0 |
| E (1064) | 1.19 | 0.52 | 0.56 | 0.39 | 0.47 | 0.79 | 0.79 | 0 |
| τ (977) | — | 467 | 300 | 254 | 443 | 282 | 316 | — |
| τ (1064) | 248 | 271 | 274 | 319 | 307 | 258 | 340 | — |
| A (532) | 2.5 | 2.0 | 2.0 | 1.8 | 1.0 | 2.5 | 3.3 | 0.2 |
| A | 20.6 | 13.6 | 14.0 | 13.4 | 6.7 | 20.2 | 27.3 | 5.4 |
| A′ | 3.9 | 3.0 | 3.7 | 3.4 | 2.3 | 4.1 | 5.2 | 1.0 |
| Y | 242 | 305 | 567 | 596 | 641 | 793 | 400 | 0 |
| Y′ | 456 | 887 | 1048 | 778 | 1115 | 1234 | 1542 | 0 |

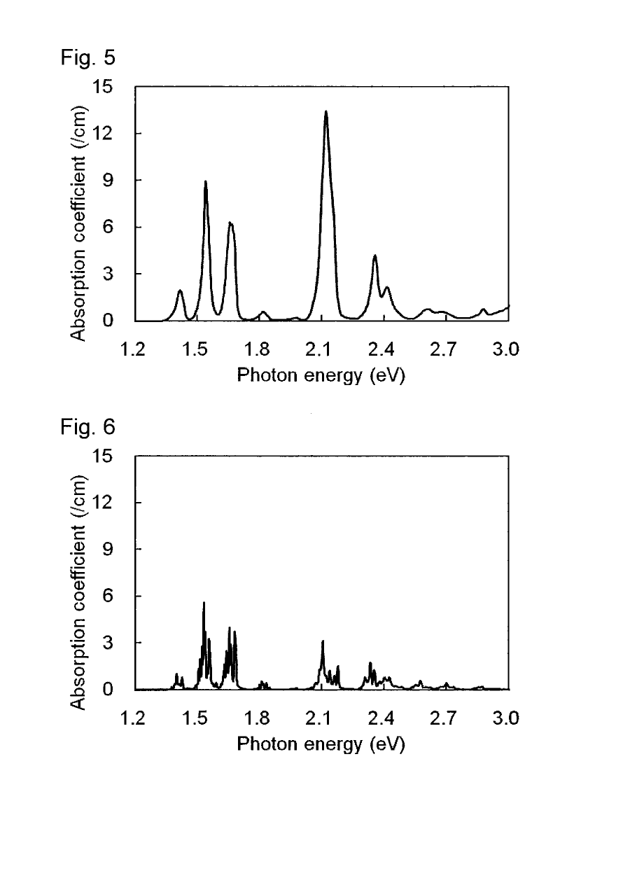

Further, FIG. 5 shows an absorption spectrum in Example 2. The vertical axis represents Absorption coefficient (unit: /cm) and the horizontal axis represents Photon energy (unit: eV). Further, FIG. 6 shows, for the purpose of comparison, an absorption spectrum of Nd-containing YAG ceramics in Example 14 wherein the proportion of Nd₂O₃ added is 0.01 by molar ratio to YAG ceramics.

The absorption peak of the glass of the present invention is 13.5/cm, while the absorption peak in FIG. 6 for comparison is 5.6/cm, and thus, it is evident that the absorption of the glass of the present invention is large in spite of the fact that the proportion of Nd₂O₃ added is the same.

Further, in the absorption spectrum in FIG. 6, fine structures are observed at the respective absorption bands, while it is evident that the glass of the present invention is free from such fine structures and capable of absorbing light over a wide wavelength range.

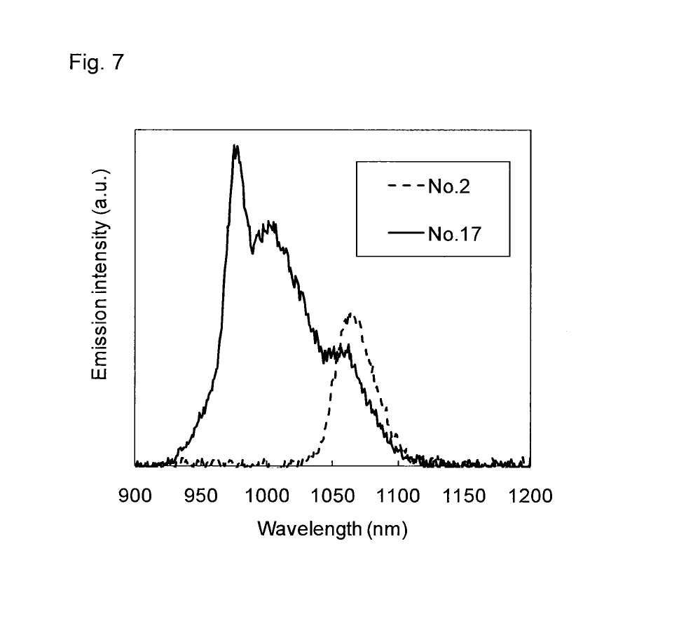

Further, FIG. 7 shows emission intensity spectra in Examples 2 and 17. The vertical axis represents Emission intensity of an arbitrary unit, and the horizontal axis represents Wavelength (unit: nm). The proportion of Nd₂O₃ added is the same as between Examples 2 and 17, but in Example 17, Yb₂O₃ is added in a proportion of 0.01 by molar ratio, whereby the emission intensity is increased.

### INDUSTRIAL APPLICABILITY

The present invention is useful for amplification of light using solar energy as an excitation light source. Further, it is useful for a laser device to convert sunlight to laser light. Further, it is useful for an amplifier for light having a wavelength of from 1.0 to 1.2 μm.

### REFERENCE SYMBOLS

10: Sunlight
20: Condensing lens
21: Reflecting surface
22: Secondary condensing lens
30, 32: Reflection mirror
31, 33: Output mirror
40, 41: Gain medium
50: Laser light
60: Signal light
70: Amplified light

What is claimed is:

1. Light-amplifying glass having Nd₂O₃ added to a matrix glass comprising from 20 to 65 mol % of B₂O₃ and from 10 to 48 mol % of Bi₂O₃, wherein the proportion of Nd₂O₃ added, is from 0.003 to 0.025 by molar ratio to the matrix glass.

2. The light-amplifying glass according to claim 1, wherein the matrix glass contains at most 60 mol % of TeO₂.

3. The light-amplifying glass according to claim 1, wherein the matrix glass contains no SiO₂.

4. The light-amplifying glass according to claim 1, wherein the matrix glass comprising from 25 to 60 mol % of B₂O₃, from 15 to 45 mol % of Bi₂O₃ and from 5 to 50 mol % of TeO₂.

5. The light-amplifying glass according to claim 4, wherein the matrix glass contains no SiO₂.

6. The light-amplifying glass according to claim 1, which contains Yb.

7. The light-amplifying glass according to claim 6, wherein the proportion of Yb₂O₃ added, is from 0.001 to 0.025 by molar ratio to the glass matrix.

8. The light-amplifying glass according to claim 7, wherein the matrix glass comprising from 25 to 60 mol % of B₂O₃, from 15 to 45 mol % of Bi₂O₃ and from 5 to 50 mol % of TeO₂.

9. The light-amplifying glass according to claim 7, wherein the matrix glass contains no SiO₂.
